(19) United States
(12) Patent Application Publication
(10) Pub. No.: US 2026/0172390 A1
(43) Pub. Date: Jun. 18, 2026

(54) Network Address Assignment Service on Network Device for Network Device Provisioning

(71) Applicant: Arista Networks, Inc., Santa Clara, CA (US)

(72) Inventors: Claus Holbech, Kirke Saaby (DK); Joseph Recchia, Hoboken, NJ (US); Guillaume Mulocher, Saint-Denis (FR)

(21) Appl. No.: 18/985,345

(22) Filed: Dec. 18, 2024

(51) Int. Cl. H04L 61/5014; H04L 41/0806

(52) U.S. Cl. CPC H04L 61/5014; H04L 41/0806

(57) ABSTRACT

A network device may be configured to provide a network address assignment service for an un-provisioned network device connected via a link. The network device may provide an assigned network address and an indication of provisioning information to the un-provisioned network device. The un-provisioned network device may obtain provisioning information based on the indication and process the provisioning information to perform a device self-provisioning operation.

### BACKGROUND

This relates to network devices, and more particularly, to network devices configured to perform device provisioning.

As an example, when initially connected to a network, a network device may be an un-provisioned network device configured to perform a self-provisioning operation by communicating with a network address assignment server.

### BRIEF DESCRIPTION OF THE DRAWINGS

FIG. 1 is a diagram of an illustrative network in which network device(s) are configured to provide network address assignment service(s) for network device provisioning in accordance with some embodiments.

FIG. 2 is a diagram of an illustrative network device in accordance with some embodiments.

FIG. 3 is a diagram of an illustrative management server that configures network devices to provide network address assignment services in accordance with some embodiments.

FIG. 4 is a diagram of an illustrative network device configured to provide a network address assignment service for provisioning connected un-provisioned network devices in accordance with some embodiments.

FIGS. 5A and 5B are illustrative network configurations in which different types of network devices provide network address assignment services in accordance with some embodiments.

FIG. 6 is a flowchart of illustrative operations for operating a management device to configure network elements for facilitating network device provisioning in accordance with some embodiments.

FIG. 7 is a flowchart of illustrative operations for operating a network device to provide a network address assignment service to facilitate network device provisioning in accordance with some embodiments.

### DETAILED DESCRIPTION

A network can convey network traffic (e.g., in the form of packets, frames, etc.) between hosts or generally between devices in the network. To properly route and forward the network traffic, the network can include a number of network devices configured with networking data such as forwarding decision data, routing decision data, network policy information, etc. Network devices typically require provisioning and the reception of networking data to be operational within the network. To simplify the process of provisioning or configuring a network device for operation, the network device may initiate its own device provisioning operation (sometimes referred to as a device self-provisioning operation).

In some network configurations, this type of self-provisioning operation can be performed by an un-provisioned network device using out-of-band network traffic (e.g., on a segmented management network different from the production network in which production traffic is conveyed). However, this can be undesirable in some scenarios and/or deployments because, to implement out-of-band provisioning, a network address assignment server (e.g., a Dynamic Host Configuration Protocol (DHCP) server) needs to be reachable on a separate segmented network and needs to be configured with appropriate information for all possible un-provisioned network devices (e.g., their network addresses, locations of their bootstrap data, etc.). The inclusion, configuration, and management of the separate segmented network and of the network address assignment server can involve substantive effort and may not be suitable for all deployments.

Accordingly, in illustrative embodiments described herein, some network device(s) may be configured to provide network address assignment service(s) to connected un-provisioned network device(s) to facilitate their self-provisioning operation(s). Doing so eliminates the need to have a centralized network address assignment server and/or eliminates the need to use a separate network (e.g., segmented management network traffic) for conveying network traffic for the device self-provisioning operations, among other advantages.

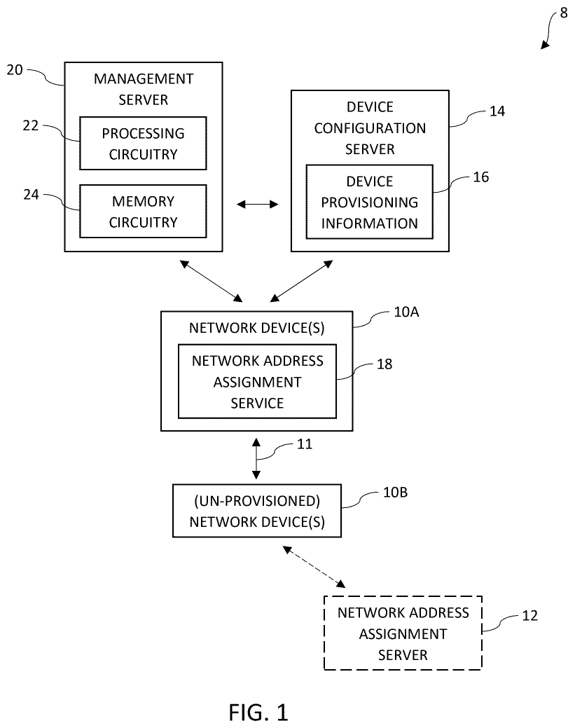

An illustrative networking system in which network device self-provisioning operations (e.g., in the manner described above) can be performed is shown in FIG. 1. In particular, FIG. 1 shows an illustrative network 8 which may be of any suitable scope and/or form part of a larger network of any suitable scope. As examples, network 8 may include, be, and/or form part of one or more local area networks (LANs), one or more local segments or virtual LANs (VLANs), one or more subnets, one or more data center networks, one or more campus area networks, one or more metropolitan area networks, one or more wide area networks, one or more cloud networks, etc.

Network 8 may include any suitable number of different network devices that communicatively couple corresponding host devices of network 8 to one another. At least some of these network devices may be connected to each other by one or more wired technologies or standards such as Ethernet (e.g., using electrical cables and/or fiber optic cables), thereby forming a wired network portion. If desired, network 8 may also include a wireless network portion (e.g., implemented using network devices such as wireless access points) coupled to the wired network portion. If desired, network 8 may include and/or be communicatively coupled to internet service provider networks (e.g., the Internet) or other public service provider networks, private service provider networks (e.g., multiprotocol label switching (MPLS) networks), and/or other types of networks such as telecommunication service provider networks.

In general, network devices in network 8 can include any number of switches (e.g., single-layer (layer 2 or layer 3) switches, multi-layer (layer 2 and layer 3) switches such as spine switches and leaf switches in one or more data center networks, etc.), routers, gateways, bridges, hubs, repeaters, firewalls, wireless access points, network devices serving other networking functions, network devices that include the functionality of two or more of these devices, management devices that control the operation of one or more of these network devices, and/or other types of network devices.

In the example of FIG. 1, the network devices of network 8 may include one or more network devices 10A and one or more network devices 10B. In illustrative configurations sometimes described herein as an example, network devices 10A and 10B may each have a routing functionality (e.g., be a multi-layer switch, a router, a gateway, etc.). Accordingly, a network device 10A or 10B may therefore sometimes be referred to as an (Open Systems Interconnection (OSI)) layer 3 (L3) network device, a network layer network device, or a routing network device. Each pair of network device 10A and network device 10B may be communicatively coupled to each other via a corresponding (OSI) L3 link 11 (sometimes referred to as a routed link 11), or more specifically, an L3 point-to-point link 11.

Configurations in which network devices 10B are un-provisioned network devices (e.g., not fully provisioned network devices) when initially connected and coupled communicatively to other elements (e.g., other network devices such as devices 10A) of network 8 are sometimes described herein as an illustrative example.

While, in some network deployments, a centralized network address assignment server such as server 12 may be provided to facilitate the device self-provisioning operations of network devices, in other network deployments, server 12 may be absent or may not be usable to facilitate the device self-provisioning operations. In these other network deployments or in other scenarios, network devices such as network devices 10A may be configured to perform at least some of the functions of server 12 (e.g., by providing network address assignment services 18) for provisioning network devices 10B.

In scenarios in which a network device 10A provides network address assignment service 18 for a network device 10B, network device 10B may further use the information provided by network device 10A (as part of network address assignment service 18) to communicate with a source of device provisioning information, such as device configuration server 14 maintaining device provisioning information 16. In some illustrative configurations, device configuration server 14 may be a file server, a File Transfer Protocol (FTP) server, a bootstrap server, a Hypertext Transfer Protocol (HTTP) server, a domain name system (DNS) server, etc. As examples, information 16 maintained on server 14 may include executable files, e.g., network device configuration data (e.g., networking data, device configuration image, etc.), and/or other provisioning information such as redirect information to other source(s) of device provisioning information, to be obtained and processed by network device(s) 10B. In illustrative configurations described herein as an example, network device 10B may be communicatively coupled to server 14 (to obtain information 16) via a network path that includes intervening network device 10A. If desired, device provisioning information 16 may be stored at a different network location (e.g., on a local device, on non-server computing equipment, etc.).

Network devices 10A may provide network address assignment services 18 by performing operations in compliance with or otherwise compatible with Dynamic Host Configuration Protocol (DHCP), including DHCP version 4 (DHCPv4) and/or DHCP version 6 (DHCPv6), by performing operations that serve as extensions of DHCP, by performing operations that are compliant with only some portions of DHCP, and/or by performing operations implementing other network address assignment protocols. When service 18 is compatible with DHCP, service 18 may be referred to as DHCP service 18. By performing these operations, network devices 10A may provide (assigned) network addresses to requesting devices such as network devices 10B and/or may provide other network information (e.g., default gateways, subnet information, etc.) to requesting devices such as network devices 10B.

As a particularly relevant example, the other network information provided by network device 10A (e.g., service 18 thereon) to requesting devices such as network devices 10B may include indications of device provisioning information. These indications (indicators) may include network addresses, other location information or locators, and/or identifiers of the sources of device provisioning information (e.g., server 14) and/or of the device provisioning information (e.g., information 16). As specific examples, the indications may include uniform resource locators (URLs) or web addresses, and/or uniform resource identifiers (URIs), of server 14 and of information 16. In configurations in which service 18 is a DHCP service, these indications may be conveyed as information in DHCP option 66, DHCP 67 option, and/or DHCP option 43.

After obtaining its network address from network device 10A, a network device 10B may generate and/or configure a network interface communicatively to network device 10A, and/or other interface(s) based on the assigned network address (and other network information obtained from device 10A). Network device 10B may then use the configured interface, or the other configured interface, to access server 14 using the indication (e.g., address and/or identifier of server 14 and/or of information 16) provided by device 10A to obtain executable files, network device configuration data, and/or other device provisioning information 16.

Network device 10B may be considered fully provisioned and ready to perform networking operations (e.g., routing protocols, traffic routing, traffic forwarding, etc.) after successfully executing the obtained executable files, storing the obtained device configuration data, and/or generally processing the provisioning information, as examples.

To orchestrate this type of network device provisioning system, a management server 20 (sometimes referred to as controller server 20 or orchestration server 20) may be provided. Management server 20 may be implemented using server hardware such as one or more blade servers, one or more rack servers, and/or one or more tower servers. Processing circuitry 22 and memory circuitry 24 for implementing the functions of management server 20 may be provided as compute devices and storage devices of the server hardware.

Processing circuitry 22 (e.g., the compute devices thereof) may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Memory circuitry 24 (e.g., the storage devices thereof) may include non-volatile memory (e.g., one or more of flash memories, electrically-programmable read-only memories, solid-state drives, hard disk drives, etc.), volatile memory (e.g., static and/or dynamic random-access memories), removable storage devices (e.g., storage devices removably coupled to server 20), and/or other types of memory circuitry. In general, memory circuitry 24 may include one or more non-transitory (tangible) computer-readable storage media that store the operating system software and/or any other software code, sometimes referred to as program instructions, software, data, instructions, or code. Processing circuitry 22 may run (e.g., execute) an operating system and/or other software (including firmware) stored on the one or more non-transitory computer-readable storage media to perform the operations of management server 20 described herein.

If desired, the management functions of management server 20 (e.g., processing circuitry 22 and memory circuitry 24) may be implemented on one or more dedicated local host devices or generally implemented using non-server hardware, instead of or in addition to server 14 as described above.

Management server 20 may manage, based on processing circuitry 22 executing software instructions stored on memory circuitry 24, the configuration of network device(s) 10A (e.g., to provide network address assignment service 18 thereon) and/or the configuration of server 14 (e.g., to provide device provisioning information 16 thereon). In the example of FIG. 1, server 20 may be communicatively coupled, via one or more communication paths in network 8, to network device(s) 10A and/or server 14. The communication paths communicatively coupling server 20 to network device(s) 10A and server 14 may be implemented using network paths of network 8. These network paths may include direct cable connections with or without intervening network devices. As an example, each of these paths may span across portions of network 8 (e.g., one or more network devices therein) to provide the connectivity illustrated in FIG. 1. Server 20 may exchange messages, via these network paths, with network device(s) 10A and/or server 14 (e.g., send network address assignment configuration information to network device(s) 10A, send network device provisioning information 16 to server 14, etc.).

Server 20 and server 14 may be implemented on distinct and separate pieces of server computing equipment (e.g., on different processing circuitry or sets of processors, using different storage circuitry accessible by the corresponding processing circuitry, on the same or different server racks, etc.) or may be implemented on shared computing equipment (e.g., the same processing circuitry or set of processors, using the same storage circuitry accessible by the processing circuitry, etc.). Server 20 and server 14 may be implemented at different sites or generally on different network portions of network 8 (e.g., on different local segments) or may be implemented at the same site (e.g., on the same local segment or different local segments).

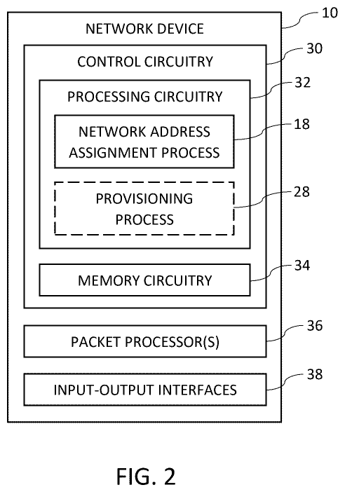

FIG. 2 is a diagram of an illustrative network device 10 that may be used to implement network device(s) 10A in FIG. 1 and/or network device(s) 10B in FIG. 1. As shown in FIG. 2, network device 10 may include control circuitry 30 having processing circuitry 32 and memory circuitry 34, one or more packet processors 36, and input-output interfaces 38 mounted within and/or on a housing of network device 10. If desired, the housing may include an exterior cover that provides protection for the components of network device 10 and/or supporting substrate(s) on which the components of network device 10 are mounted. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 32 may include one or more processors such as central processing units (CPUs), graphics processing units (GPUs), microprocessors, general-purpose processors, host processors, coprocessors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 32 may run (e.g., execute) a network device operating system and/or other software (including firmware) that is stored on memory circuitry 34. Memory circuitry 34 may include one or more non-transitory (tangible) computer-readable storage media that store the operating system software and/or any other software code, sometimes referred to as program instructions, software instructions, software, data, instructions, or code.

As an example, the transmission, reception, and/or processing of various types of communication with other network device(s) (e.g., network devices 10B, network devices 10A, etc.) and/or server 14 as described herein (e.g., as part of a device self-provisioning operation including a network address assignment operation) may be stored as (software) instructions on the one or more non-transitory computer-readable storage media (e.g., in portion(s) of memory circuitry 34). The corresponding processing circuitry (e.g., one or more processors of processing circuitry 32) may process or execute the respective instructions to perform the transmission, reception, and/or processing of the various types of communication with the other network device(s) and/or server 14. Memory circuitry 34 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry. Processing circuitry 32 and (at least the portion of) memory circuitry 34 as described above may sometimes be referred to collectively as control circuitry 30 (e.g., implementing a control plane of network device 10).

As other illustrative operations in addition to the above-mentioned operations, processing circuitry 32 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 36, may store packet forwarding information, may execute packet processing software, and/or may execute other software instructions that control the functions of network device 10 and the other components therein.

Packet processor(s) 36 may be used to implement a data plane or forwarding plane of network device 10. Accordingly, packet processor(s) 36 may sometimes be referred to as a data plane processing circuitry or data plane processor(s) 36. Packet processor(s) 36 may include one or more processors such as programmable logic devices such as field programmable gate array (FPGA) devices, application specific system processors (ASSPs), application specific integrated circuit (ASIC) processors, central processing units (CPUs), graphics processing units (GPUs), microprocessors, general-purpose processors, host processors, coprocessors, microcontrollers, digital signal processors, and/or other types of processors.

Packet processor 36 may receive incoming network traffic via input-output interfaces 38 (and/or internal interfaces), parse and analyze the network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on memory circuitry integrated as part of and/or separate from packet processor 36 (e.g., on content-addressable memory), and/or on a portion of memory circuitry 34. Memory circuitry for packet processor 36 may similarly include volatile memory and/or non-volatile memory.

Input-output interfaces 38 may include one or more different types of communication interfaces such as Ethernet interfaces, optical interfaces, network layer (e.g., Internet Protocol (IP) such as IPv4 and/or IPv6) interfaces, wireless interfaces such as wireless personal area network interfaces and wireless local area network interfaces, and/or other communication interfaces for connecting network device 10 to the Internet, one or more local area networks, one or more wide area networks, and/or generally other network device(s), peripheral devices, and computing equipment (e.g., host equipment such as server equipment).

In illustrative configurations described herein as an example, input-output interfaces 38 may include Ethernet interfaces implemented using and therefore include (Ethernet) ports. In particular, OSI layer 2 (L2) or data link layer interface circuitry may be coupled to the ports to form Ethernet interfaces with the desired interface configuration. Processing circuitry 32 may further form (e.g., configure) L3 or network layer (e.g., IPv4 and/or IPv6) interfaces over the Ethernet interfaces and ports. The ports, over which L2 and L3 interfaces are implemented, may be physically coupled and electrically connected to corresponding mating connectors of external equipment, when received at the ports, and may have different form-factors to accommodate different cables, different modules, different devices, or generally different external equipment.

The components of device 10 shown in FIG. 2 are merely illustrative. If desired, network device 10 may include other components such as power management circuitry, thermal management components (e.g., heatsinks, fans, etc.), etc. In general, the components of device 10 may be communicatively coupled to each other, or at least to processing circuitry 32 and/or memory circuitry 34 via corresponding signal paths. These signal paths may be configured to convey power (e.g., supply voltage(s)), control signals, data signals, and/or other information between the inter-coupled components of device 10.

In illustrative configurations in which device 10 of FIG. 2 implements network devices 10A in FIG. 1 (e.g., devices that provide network address assignment services), processing circuitry 32 of network device 10 (e.g., of network device 10A) may execute a network address assignment service 18, sometimes referred to as a network address assignment process 18 (implementing the corresponding service). In configurations in which network address assignment uses DHCP, process 18 may be referred to as a DHCP process.

As examples, when executing (software) instructions for network address assignment process 18, processing circuitry 32 of network device 10A (FIG. 1) may receive network address assignment messages (e.g., request messages from devices 10B), may process the received network address assignment messages, may generate and transmit network address assignment messages (e.g., reply messages to device 10B), among other operations. Configurations in which the network address assignment messages are DHCP messages are sometimes described herein as examples.

In illustrative configurations in which device 10 of FIG. 2 implements network devices 10B in FIG. 1 (e.g., un-provisioned devices that perform self-provisioning), processing circuitry 32 of network device 10 (e.g., of network device 10B) may execute a provisioning process 28. In particular, network device 10B may be a network device that automatically initiates a device provisioning operation to provision itself after being introduced to network 8 in FIG. 1 (e.g., after being communicatively coupled to components of network 8 such as network device 10A).

When executing (software) instructions for device provisioning process 28, processing circuitry 32 of network device 10B (FIG. 1) may help manage and facilitate a device self-provisioning operation after the initially un-provisioned device 10B is supplied with power and is communicatively coupled to network device 10A and/or other components of network 8. If desired, this provisioning operation may be initiated automatically by executing process 28 based on one or more criteria being met. The one or more criteria can include network device 10B being connected to a power source, network device 10B being coupled to one or more elements of network 8, network device 10B lacking an initial configuration, network device 10B receiving one or more user inputs such as the pressing of a button, the providing of a key or other security element, or generally any specified input via a user interface, and/or other suitable provisioning criteria. Configured in this manner, network device 10B may sometimes be referred to herein as a network device configured for secure zero touch provisioning, zero touch provisioning, one touch provisioning, or minimal touch provisioning.

In illustrative configurations described herein as an example, network device 10 may be configured to facilitate device self-provisioning by performing non-secure provisioning operations based on one or more non-secure provisioning protocols (e.g., a zero touch provisioning (ZTP) protocol in compliance with one or more Requests for Comments (RFCs) such as RFC 2131, RFC 2132, RFC 8415, etc., a non-standardized or proprietary ZTP protocol, etc.) and to facilitate device self-provisioning by performing secure provisioning operations based on one or more secure provisioning protocols (e.g., a secure zero touch provisioning (SZTP) protocol in compliance with one or more RFCs such as RFC 8572, RFC 8415, etc., a non-standardized or proprietary SZTP protocol, etc.).

As part of the device provisioning operation, device 10B (e.g., device provisioning process 28 executing on processing circuitry thereon) may obtain network information including the network address (e.g., the Internet Protocol (IP) address) assigned to network device 10B, subnet information, a default gateway network address, etc. If desired, these operations of obtaining network information may be obtained by a client-side network address assignment process (e.g., one or more DHCP clients) executing on processing circuitry 32 of device 10B. Processing circuitry 32 of device 10B may use the obtained network information (e.g., assigned network address) to form one or more network interfaces 38 (e.g., IP interfaces such as one or more IP version 4 (IPv4 ) or IP version 6 (IPv6 ) interfaces) for device 10B. Processing circuitry 32 of device 10B may also obtain an identifier or address of a given provisioning information source. Processing circuitry 32 may subsequently communicate with the source to obtain provisioning information (e.g., executable files, device configuration data, and/or other types of provisioning information).

Processing circuitry 32 may execute process 18 (e.g., when implementing device 10A) and/or may execute process 28 (e.g., when implementing device 10B) by executing software instructions stored on memory circuitry 34. While process 18 and process 28 are described to perform parts of the network address assignment service and the device provisioning operation, respectively, this is merely illustrative. Processing circuitry 32 may be organized in any suitable manner (e.g., to execute any other agents or processes instead of or in addition to process 18 or process 28) to perform parts of the network address assignment service or the device provisioning operation. Accordingly, processing circuitry 32 may sometimes be described herein to perform the network address assignment service or the device provisioning operation instead of specifically referring to the one or more agents, processes, and/or kernel executed by processing circuitry 32.

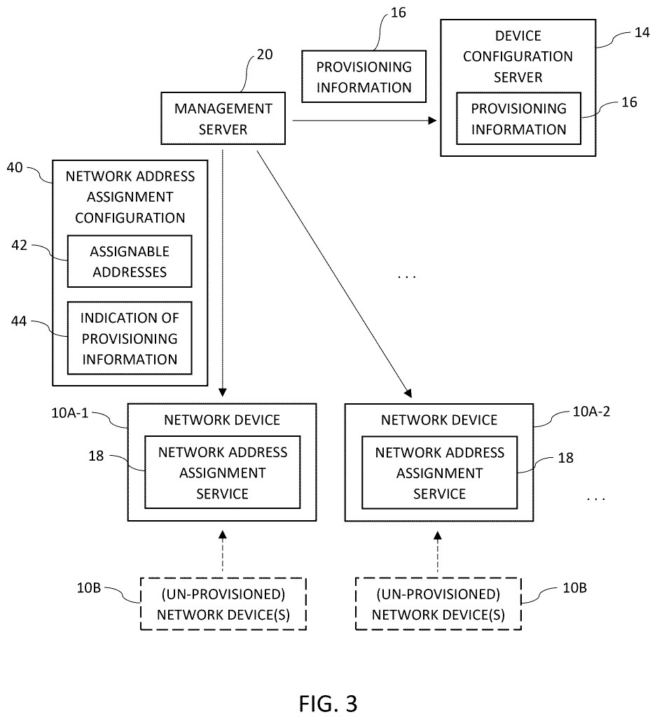

To set up network 8 (FIG. 1) to facilitate network device provisioning using network-device-implemented network address assignment service, management server 20 may be configured to communicate with device configuration server 14 and one or more network devices 10A. FIG. 3 is a diagram of illustrative communication from a management server 20 to set up network device provisioning using network-device-implemented network address assignment services.

As shown in FIG. 3, management server 20 (e.g., processing circuitry 22 thereof) may generate and transmit provisioning information 16 to server 14, e.g., over network path(s) in network 8 (FIG. 1). As an example, provisioning information 16 may be generated by processing circuitry 22 based on user input (e.g., a network administrator providing input, e.g., a configuration file, on the desired network configuration to set up network device provisioning).

As some illustrative types of provisioning information 16 conveyed to and stored by server 14, provisioning information 16 may include an executable file that when executed by un-provisioned device 10B causes device 10B to perform a set of processing steps to complete its self-provisioning, may include an executable file that when executed by un-provisioned device 10B causes device 10B to communicate with an actual source of device configuration data to further obtain the device configuration data for storage, may include device configuration data (e.g., a device startup configuration) that when stored or otherwise processed by device 10B completes its self-provisioning, may include redirect information (e.g., an address or identifier of another server or source of provisioning information), and/or may include other information that helps with the provisioning of device 10B to reach an operational state.

Because server 14 may store provisioning information 16 for different types of network devices such as network devices serving different functions in network 8, network devices at different relative network locations within network 8 (FIG. 1), network devices having different capabilities, etc., different sets of provisioning information 16 may be stored for the different types of network devices, if desired. As an example, processing circuitry 22 of server 20 may generate and transmit, to server 14 for storage, a first set of provisioning information 16 (containing any combination of types of provisioning information described above) to provide to one or more un-provisioned network devices 10B (e.g., of a first type), may generate and provide a second set of provisioning information 16 (containing any combination of types of provisioning information described above) to provide to one or more un-provisioned network devices 10B (e.g., of a second type), etc.

As further shown in FIG. 3, management server 20 (e.g., processing circuitry 22 thereof) may generate and transmit network address assignment configuration (information) 40 (sometimes referred to as network address assignment configuration file 40) to each of network devices 10A (FIG. 1) such as network device 10A-1, network device 10A-2, and other network device(s) 10A, e.g., over network paths in network 8. As an example, network address assignment configuration information 40 may be generated by processing circuitry 22 based on user input (e.g., a network administrator providing input, e.g., a configuration file, on the desired network configuration to set up network device provisioning) and/or in coordination with provisioning information 16 provided to server 14.

As examples, network address assignment configuration information 40 may include an indication to provide or enable network address assignment service on the receiving device 10A and other information for configuring the provided network address assignment service provided on device 10A, such as network addresses 42 to be assigned to un-provisioned device 10B (e.g., to the interface of device 10A connected to device 10B), indications 44 of sources of provisioning information for device 10B, default gateway network addresses, subnet information, etc. In particular, indication 44 may be an address or identifier of server 14 and/or information 16 thereon.

Some content in network address assignment configuration information 40 that is transmitted to different devices 10A may be different. As an example, assignable addresses 42 provided in information 40 sent to network device 10A-1 may be different from assignable addresses 42 provided in information 40 sent to network device 10A-2.

Other content in network address assignment configuration information 40 that is transmitted to different devices 10A may be the same. As an example, indication 44 of provisioning information sent to network device 10A-1 and sent to network device 10A-2 may be the same and may both include the same address of server 14 (e.g., a URL of server 14), and/or may identify a location of the same set of provisioning information 16 (e.g., a URL of information 16).

These examples are merely illustrative. If desired, information 40 for each network device 10A may be generated to include the same and/or different content as desired to implement a particular network configuration (e.g., based on a configuration specified by user input).

Once a network device 10A obtains (e.g., receives) its network address assignment configuration information 40 from management server 20, the network device 10A may implement a network address assignment service (e.g., execute process 18 on processing circuitry 32 thereof) based on the obtained configuration information 40. As shown in FIG. 3, network device 10A-1 (e.g., processing circuitry 32 thereof) may obtain first configuration information 40 and may execute network address assignment 18 based on the obtained first configuration information 40. Network device 10A-2 (e.g., processing circuitry 32 thereof) may obtain second configuration information 40 and may execute network address assignment 18 based on the obtained second configuration information 40.

After setting up network address assignment services 18 on network devices 10A-1 and 10A-2, these network devices 10A may be ready to facilitate the self-provisioning operation of any un-provisioned network devices 10B communicatively coupled to them. In particular, when one or more network devices 10B is communicatively coupled to device 10A-1, processing circuitry 32 of device 10A-1 may use its configured network address assignment service 18 to facilitate the provisioning of these network device(s) 10B. When one or more network devices 10B is communicatively coupled to device 10A-2, processing circuitry 32 of device 10A-2 may use its configured network address assignment service 18 to facilitate the provisioning of these network device(s) 10B.

In the example of FIG. 3, management server 20 is described to provide the appropriate information to server 14 and network devices 10A. This is merely illustrative. If desired, server 14 and network devices 10A may be configured or otherwise receive the appropriate information in other manners, e.g., user input such as configuration file(s) may be directly received by devices 10A such that the desired service 18 is configured thereon, user input such as configuration files may be directly received by server 14 to store corresponding provisioning information 16.

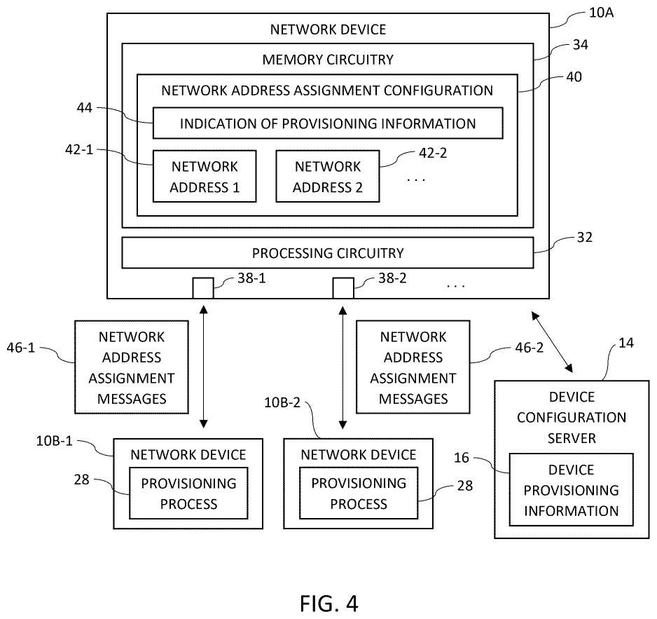

Once a network device 10A (e.g., processing circuitry 32 thereof) is executing the desired network address assignment service 18, processing circuitry 32 of device 10A may communicate with a connected un-provisioned network device to facilitate its self-provisioning operation. FIG. 4 is a diagram of an illustrative network device 10A (e.g., device 10A-1 or device 10A-2 in FIG. 3) providing a network address assignment service to facilitate the provisioning of network devices 10B connected on different interfaces.

As shown in FIG. 4, processing circuitry 32 of device 10A may store network address assignment configuration information 40 (e.g., obtained in the manner described in connection with FIG. 3) on memory circuitry 34 of device 10A. Processing circuitry 32 of device 10A may provide a corresponding network address assignment service (e.g., by executing process 18 in FIG. 2) based on the stored information 40.

In the example of FIG. 4, a first un-provisioned network device 10B-1 (e.g., one instance of device 10B in FIG. 1) may be communicatively coupled to an interface 38-1 of device 10A via a link (e.g., a routed point-to-point link 11 in FIG. 1). Network device 10B-1 (e.g., processing circuitry 32 thereof) may execute a provisioning process 28 to perform device self-provisioning. As part of the initial steps of device provisioning, network device 10B-1 may exchange network address assignment messages 46-1 (e.g., DHCP messages) with processing circuitry 32 of network device 10A to obtain network information (e.g., a network address assigned to network device 10B-1, a network address of a default gateway, a location of provisioning information, etc.).

In particular, processing circuitry 32 of device 10A may receive a network address assignment request (e.g., in a first message 46-1) transmitted from network device 10B-1. As examples, the received request may be a DHCPv4 request, a DHCPv6 stateful request, a DHCPv6 stateless request, and/or other types of requests. Responsive to the received request, processing circuitry 32 of device 10A may generate and transmit a corresponding network address assignment reply (e.g., in a second message 46-1) to network device 10B-1.

The generated and transmitted reply may include a network address 42-1 assigned to a network device connected via interface 38-1 (device 10B-1 in this example), may include indication 44 of provision information for device 10B-1, and/or may include other appropriate information defined in configuration information 40.

Network device 10B-1 (e.g., when executing provisioning process 28) may perform the device self-provisioning operation based on the information contained in the reply transmitted by network device 10A. As an example, network device 10B-1 may generate and configure interface(s) (e.g., the interface of device 10B-1 communicatively coupled to device 10A) based on assigned address 42-1 and/or other interface configuration information in the reply.

Network device 10B-1 may further attempt to access provisioning information (e.g., indicated by indication 40 in the received reply) over the generated interface(s). In particular, network device 10B-1 may transmit network traffic to server 14 (e.g., indicated by indication 40) to access provisioning information 16. Because network device 10A is an intervening network device between device 10B-1 and server 14, the network traffic transmitted by device 10B-1 may be received by network device 10A at interface 38-1 and may be forwarded (e.g., by data plane processor(s) 36 of device 10A) toward server 14. Similarly, network traffic containing device provisioning information 16 may be conveyed from server 14 to network device 10B-1 via network device 10A (e.g., forwarded by data plane processor(s) of device 10A toward device 10B-1 via interface 38-1).

After obtaining device provisioning data 16, network device 10B-1 may process the obtained information 16 to provision network device 10 (e.g., by executing executable files therein, by storing device configuration data therein, etc.). In scenarios in which these operations are successfully completed, network device 10B-1 may be fully provisioned and may be operational within the network (e.g., may proceed with normal network operations such as the forwarding and general processing of network traffic).

In a manner similar to the manner in which device 10B-1 is provisioned, network device 10B-2 communicatively coupled to interface 38-2 of network device 10A may also be provisioned. As examples, network device 10B may similarly exchange network address assignment messages 46-2 with processing circuitry 32 of device 10A to obtain an assigned network address (e.g., a network address 42-2 different from address 42-1) and to obtain indication 40 of provisioning information, may similarly configure network interfaces using assigned address 42-2, may similarly obtain device provisioning information 16 via network device 10A (e.g., via interface 38-2 to transmit traffic to and to receive traffic from server 14 to obtain provisioning information 16), and may similarly process the obtained provisioning information 16 to complete provisioning.

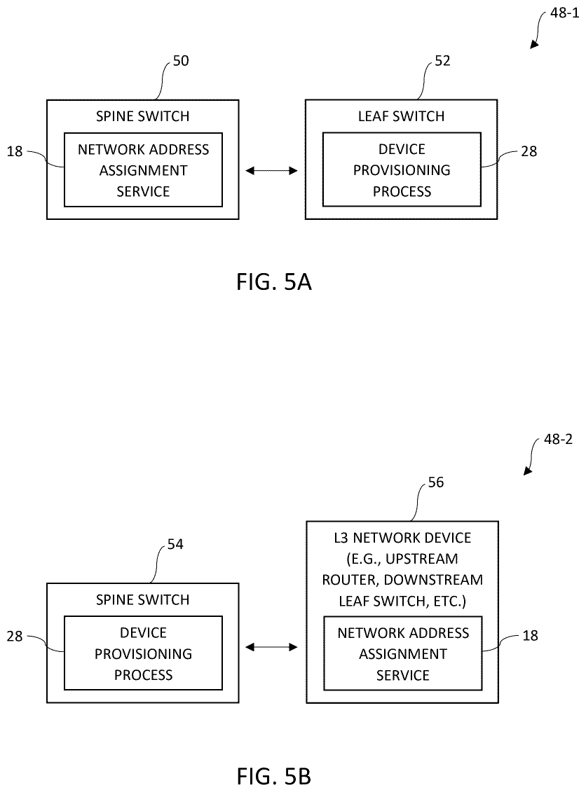

Different types of network devices may provide network address assignment services and/or different types of network devices, when initially un-provisioned, may make use of these provided network address assignment services. As one illustrative example, in network configuration 48-1 (e.g., a first network deployment of a data center network) shown in FIG. 5A, a spine switch 50 may perform the operations described herein in connection with network device 10A to provide network address assignment service 18. The provided network address assignment service 18 may be used to provision an initially un-provisioned leaf switch 52 performing the operations described herein in connection with network device 10B (e.g., by executing device provisioning process 28).

As one illustrative example, in network configuration 48-2 (e.g., a second network deployment of a data center network) shown in FIG. 5B, an L3 network device 56 may perform the operations described herein in connection with network device 10A to provide network address assignment service 18. The provided network address assignment service 18 may be used to provision an initially un-provisioned spine switch 54 performing the operations described herein in connection with network device 10B (e.g., by executing device provisioning process 28). L3 network device 56 may be a network device, such as a router or a gateway, that is upstream from (e.g., closer to the core network than and/or farther from the end hosts than) spine switch 54, may be a network device, such as a leaf switch, that is downstream from (e.g., farther from the core network than and/or closer to the end hosts than) spine switch 54, or may be another network device (e.g., another spine switch).

The examples of FIGS. 5A and 5B are merely illustrative. In general, other types of network devices may perform the operations described herein in connection with network devices 10A and 10B.

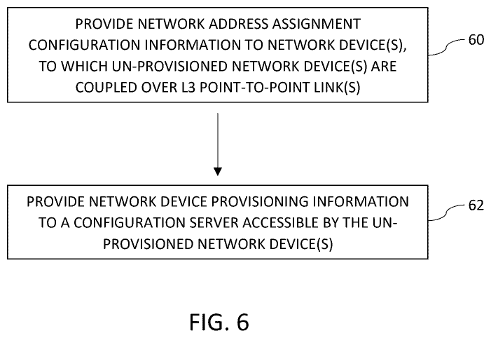

FIG. 6 is a flowchart of illustrative operations for setting up a network to perform (in-band) network device self-provisioning (e.g., using network-device-implemented network address assignment services). These operations may be performed at one or more processors of processing circuitry such as processing circuitry 22 of server 20 (e.g., as described in connection with FIGS. 1-5). The illustrative operations described in connection with FIG. 6 may generally be performed by the processing circuitry executing software instructions stored on memory circuitry such as memory circuitry 24 of server 20 (e.g., as described in connection with FIGS. 1-5). If desired, one or more operations described in connection with FIG. 6 may be performed by other dedicated hardware components on computing equipment (e.g., on server 20). If desired, non-server computing equipment may perform the operations described in connection with FIG. 6.

At block 60, one or more processors (e.g., processing circuitry 22 of server 20) may provide network address assignment configuration information to one or more network devices. The one or more network devices may each be communicatively coupled to one or more other un-provisioned network devices over corresponding L3 point-to-point link(s). The network address assignment configuration information when processed by the one or more network devices may implement network address assignment services on the one or more network devices. These implemented network address assignment services may be used to reply to network address assignment requests sent by the un-provisioned network devices.

At block 62, the one or more processors may provide network device provisioning information to a configuration server (e.g., a file server, a bootstrap server, a HTTPS server, etc.) accessible by the un-provisioned network device(s). The configuration server may be accessible by the un-provisioned network device(s) via corresponding intervening network devices provided with the network address assignment configuration information (at block 60) and implementing network address assignment services.

As an example, the operations performed at blocks 60 and 62 may include the operations performed by management server 20 as described in connection with FIGS. 1 and 3.

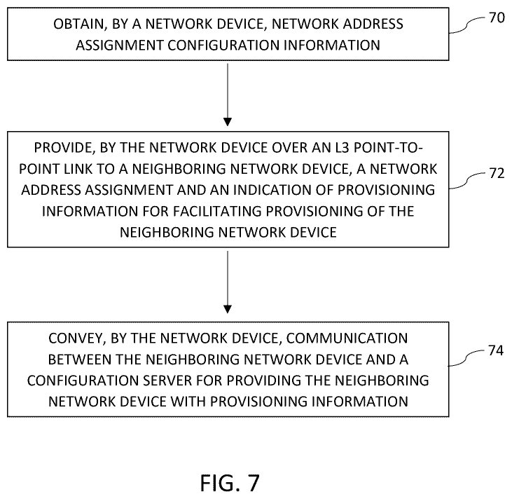

FIG. 7 is a flowchart of illustrative operations for performing network device self-provisioning (e.g., using network-device-implemented network address assignment services). These operations may be performed at one or more processors of processing circuitry such as processing circuitry 32 of device(s) 10A (e.g., as described in connection with FIGS. 1-5). The illustrative operations described in connection with FIG. 7 may generally be performed by the processing circuitry executing software instructions stored on memory circuitry such as memory circuitry 34 of device(s) 10A (e.g., as described in connection with FIGS. 1-5). If desired, one or more operations described in connection with FIG. 7 may be performed by other dedicated hardware components on computing equipment (e.g., packet processor(s) 36 on network device(s) 10A).

At block 70, one or more processors (e.g., processing circuitry 32 of a network device 10A) may obtain network address assignment configuration information. The network address assignment configuration information may be obtained by the one or more processors from a management server (e.g., processing circuitry 22 of server 20 as described in connection with block 60 of FIG. 6) and/or directly based on user input (e.g., a configuration file received via user input).

At block 72, the one or more processors may provide, over an L3 point-to-point link, a network address assignment (e.g., an assigned network address) and an indication (e.g., an identifier of, an address or location of, etc.) of provisioning information to a neighboring un-provisioned network device. The provisioning information, when obtained and processed by the neighboring un-provisioned network device, may be usable for facilitating self-provisioning of the neighboring un-provisioned network device. The providing of the information at block 72 may be performed as part of a network address assignment service implemented on the network device based on the configuration information obtained at block 70.

At block 74, the one or more processors (e.g., packet processor(s) 36 on network device 10A) may convey (e.g., forward, route, etc.) communication between the neighboring network device and a configuration server that provides the neighboring network device with provisioning information. The configuration server and/or the provision information on the configuration server may be indicated by the indication provided at block 72. The operations at block 74 may be performed because the network device that is configured to perform network address assignment (at block 70) may be an intervening network device (along the production network path) between the configuration server and the neighboring un-provisioned network device. Accordingly, the operations described in connection with FIG. 7 may sometimes be referred to herein as facilitating in-band network device provisioning.

As an example, the operations performed at blocks 70, 72, and 74 may include the operations performed by network devices 10A (including network devices 10A-1 and 10A-2) as described in connection with FIGS. 1, 3, and 4.

The methods and operations described above in connection with FIGS. 1-7 may be performed by the components of one or more network devices and/or servers or other host equipment using software (including firmware) and/or hardware (e.g., dedicated circuitry or hardware). Software code for performing these operations may be stored on one or more non-transitory computer-readable storage media (e.g., tangible computer-readable storage media) on one or more of the components of the network device(s) and/or servers or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer-readable storage media may be executed by processing circuitry on one or more network devices and/or servers or other host equipment (e.g., processing circuitry 32 of network device(s) 10A, processing circuitry 22 on server 20, etc.).

The foregoing is merely illustrative and various modifications can be made to the described embodiments. The foregoing embodiments may be implemented individually or in any combination.

What is claimed is:

1. A network device comprising:
an input-output interface;
memory circuitry; and
processing circuitry coupled to the memory circuitry and the input-output interface and configured to:
provide a network address assignment service for an un-provisioned network device communicatively coupled to the input-output interface by:
receiving, from the un-provisioned network device, a network address assignment request message; and
responsive to the received network address assignment request message, transmitting, to the un-provisioned network device, a network address assignment reply message that includes a network address assigned to the un-provisioned network device and that includes an indication of network device provisioning information usable to provision the un-provisioned network device.

2. The network device defined in claim 1, wherein the indication of network address provisioning information includes an address of a device configuration server.

3. The network device defined in claim 2, wherein the processing circuitry is configured to forward first network traffic from the un-provisioned network device to the device configuration server and to forward second network traffic from the device configuration server to the un-provisioned network device.

4. The network device defined in claim 3, wherein the second network traffic includes network device provisioning information.

5. The network device defined in claim 1, wherein the processing circuitry is configured to receive network address assignment configuration information from a management server and to provide the network address assignment service based on the received network address assignment configuration information.

6. The network device defined in claim 1, wherein the network address assignment request and reply messages are Dynamic Host Configuration Protocol (DHCP) messages.

7. The network device defined in claim 1, wherein the network device and the un-provisioned network device each include a routing functionality.

8. The network device defined in claim 7, wherein the input-output interface is communicatively coupled to the un-provisioned network device via a routed point-to-point link.

9. The network device defined in claim 7, wherein the un-provisioned network device is a leaf switch.

10. The network device defined in claim 9, wherein the network device is a spine switch.

11. The network device defined in claim 7, wherein the un-provisioned network device is a spine switch.

12. The network device defined in claim 11, wherein the network device is a leaf switch, a router, or a gateway.

13. A management server comprising:
memory circuitry; and
processing circuitry coupled to the memory circuitry and configured to:
provide network device provisioning information to a device configuration server; and
provide network address assignment configuration information to a plurality of network devices for implementing a network address assignment service on each of the plurality of network devices, the network address assignment information including an indication of the network device provisioning information.

14. The management server defined in claim 13, wherein the plurality of network devices are each a layer 3 (L3) network device.

15. The management server defined in claim 14, wherein each network device in the plurality of network devices is configured to implement the network address assignment service for un-provisioned network devices communicatively coupled via L3 point-to-point links.

16. A method of operating a network device, the method comprising:
obtaining network address assignment configuration information;
providing a network address assignment service based on the obtained network address assignment configuration information;
providing, over a routed link, an assigned network address and an indication of device provisioning information to an un-provisioned network device; and
forwarding network traffic for the un-provisioned network device.

17. The method defined in claim 16, wherein the network traffic forwarded for the un-provisioned network device is forwarded toward a server indicated by the indication of device provisioning information.

18. The method defined in claim 17 further comprising:
exchanging network address assignment messages with the un-provisioned network device, wherein a given message in the network address assignment messages includes the assigned network address and the indication of device provisioning information.

19. The method defined in claim 18, wherein the network address assignment messages comprise Dynamic Host Configuration Protocol (DHCP) messages.

20. The method defined in claim 19, wherein the indication of device provisioning information is contained in at least one of DHCP option 43, DHCP option 66, or DHCP option 67 of a given DHCP message.
